(19) United States
(12) Patent Application Publication
(10) Pub. No.: US 2007/0234615 A1
(43) Pub. Date: Oct. 11, 2007

(54) Magnetic personal advertiser

(76) Inventor: Jerome S. Pendzich, Hampton, TN (US)

Correspondence Address: LAU & ASSOCIATES, LLC;MICHAEL N. LAU, 2121 EISENHOWER AVENUE, SUITE 503A, ALEXANDRIA, VA, 22314, US

(21) Appl. No.: 11/643,716

(22) Filed: Dec. 22, 2006

Related U.S. Application Data
(60) Provisional application No. 60/764,744, filed on Feb. 3, 2006.

(51) Int. Cl. G09F 7/04

(52) U.S. Cl. 40/600

(57) ABSTRACT

A magnetic sheet (10) foundation that displays a headline (18) and or a blank white area (22) for applying permanent ink marker and or a description of a product or service.

This patent application is filed under 35 U.S.C. 119(e) claiming the priority date of U.S. Provisional Patent Application No. US60/764,744 filed on Feb. 3, 2006 by inventor Jerome Pendzich.

### BACKGROUND

1. Field of Invention

This invention relates to the FOR SALE sign especially those placed on or in automobiles for public display and advertisement of an owner's car, truck, metal based vehicle, or product.

2. Description of Prior Art

The FOR SALE sign has been used by individuals and companies alike for affordable on the spot advertising. An eye-catching sign that provides a space for personalized information. The one place where this is most prevalent is in the automotive industry. Almost every auto parts store sells a FOR SALE sign that you must tape to the inside of your vehicles window to get effective visual coverage of the sign. This is semi dangerous and can obstruct a drivers view as well. The conventional sign is made of a light weight plastic and often cracks and drys out in the sun when placed behind glass. Also by taping the sign to yow window, the tape itself heats up in the sun and leaves glue residue all over the window where the sign was fastened by tape to the glass. Cleaning the glass surface of the cooked on glue residue is also very difficult.

### OBJECTS AND ADVANTAGES

Several objects and advantages of the present invention are:
(a) to provide a sign that is more efficient
(b) to provide user friendly
(c) to provide more space for personal written description
(d) to provide bigger lettering in the same space as conventional
(e) to provide a sign with a strong magnetic backing
(f) to provide an unobstructed view for a vehicle operator
(g) to provide easy clean up
(h) to provide easy to reposition
(i) to provide easy to apply
(j) to provide easy to remove
(k) to provide multiple options for visual placement
(l) to provide an improvable platform
(m) to provide a customizable printing
(n) to provide replacement parts
(o) to provide custom service
(p) to provide custom colors
(q) to provide many languages

Further objects and advantages are to provide a magnetic For Sale sign in many varieties for many applications and ease of use.

### SUMMARY OF THE INVENTION

In accordance with the present invention, a 4 SALE or FOR SALE sign with a magnetic backing which leaves a visible blank space for personalized information which can be added by permanent magic marker.

### DRAWINGS

In the drawings closely related figures have the same number but different alphabetic suffixes.

FIG. 1A to 1B shows an efficient cost effective layered assembly of a magnetic 4 SALE sign for personal advertisement

FIG. 2 shows a two piece layered version of a 4 SALE sign

FIG. 3 shows an efficient cost effective layered assembly of a magnetic FOR SALE sign for personal advertisement

FIG. 4 shows a two piece layered version of a FOR SALE sign.

### DETAILED DESCRIPTION

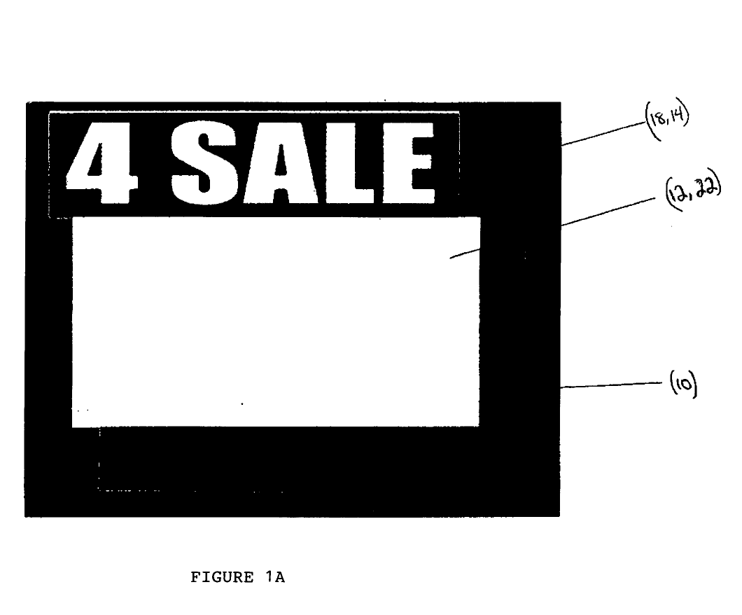

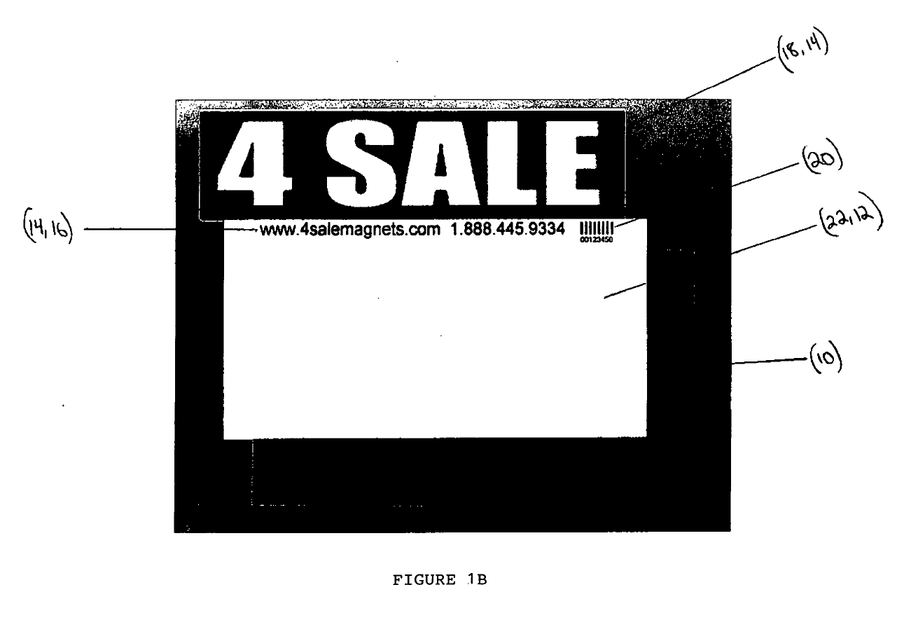

### Description—FIGS. 1A and 1D—Preferred Embodiment

A magnetic sheet that is embellished to resemble a 4 SALE sign. The number four allows a bigger eye catching advertisement in the same space as the traditional FOR SALE sign. There are two less alphabetic characters in the headline portion of the magnetic 4 SALE personal advertisement, allowing more overall space for user, producer, and reader.

### It also provides more room for custom description of a product

A preferred embodiment of the 4 SALE personal advertiser would be one comprised of a magnetic base (10) or foundation. 4 SALE headline (18,14) with a blank white background (12,22) would be applied to magnet (10) surface to provide a space for custom description which can be inserted by permanent ink magic marker (12,22). A custom professional print out of personalized description can be added upon request.

In this example a base white ink absorbent vinyl sticker (12,22) is applied to the face of a magnetic sheet (10) that is 3 millimeters thick. A (semi) permanent printed sticker which reads 4 SALE (18,14) is then inserted on top as a headline (14,18). These are stickers (12,18, 22) so they are able to be covered over by another fresh new sticker which saves a customer money and shipping for cheap updates of info, mistakes, reuse, etc. The stickers also can become removable from magnet base (10) for reuse, recycle, etc. This headline (18) can also be translated into many languages.

### FIG. 1B

the same as the description of FIG. 1 with the addition of an advertisement (16) and contact info along with a U.P.C. symbol (20) or Bar code for easy scanning of price and item code.

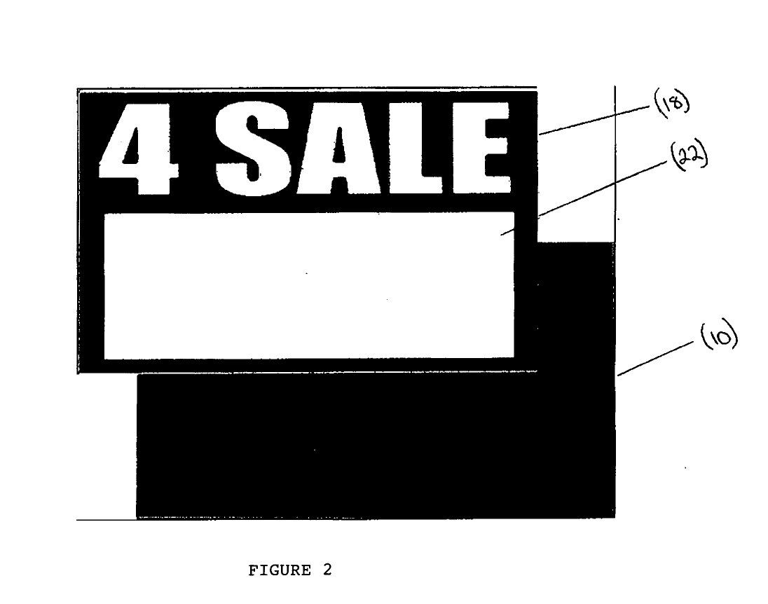

### FIG. 2—Additional Embodiment

A large area (semi) permanent print out on ink absorbent vinyl (12,14,18,22 )which adheres to a 3 millimeter thick magnetic sheet base (10). This enables permanent ink marker to be used as a basic form of adding personalized information or description (12). It also allows a professional printout of personal description to be printed directly into the open white space. 4 SALE is used as a headline (18) because it provides bigger characters in the same space as FOR SALE. This allows many benefit such as smaller sizes for narrow body panels, more readable eye catching headlines, more overall space for custom description, a tidy appearance, etc. This headline (18) can also be translated into many languages.

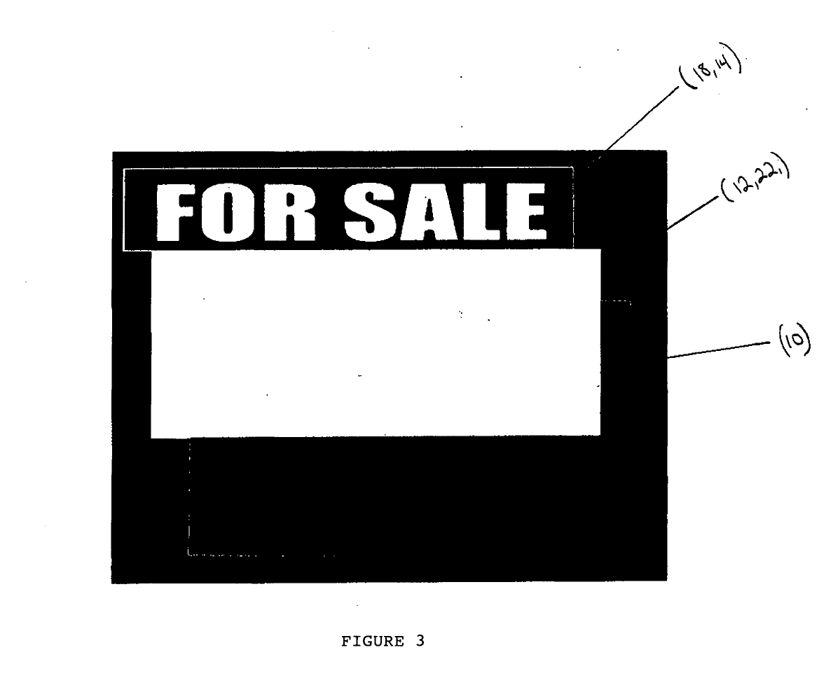

### FIG. 3—Alternative Embodiment

An alternative embodiment of the 4 SALE personal advertiser would be one comprised of a magnetic base or foundation (10). A FOR SALE headline (18) with a blank white background (12) would be applied to magnet surface (10) to provide a space for custom description which can be inserted by permanent ink magic marker. A custom professional print out of personalized description can be added upon request. This headline (18) can also be translated into many languages.

In this example a base white ink absorbent vinyl sticker (12) is applied to the face of a magnetic sheet (10) that is 3 mil. thick. A (semi) permanent printed sticker (14,18) which reads FOR SALE is then inserted on top as a headline(18). These are stickers (12,14,16,18,20, 22) so they are able to be covered over by another fresh new sticker which saves a customer money and shipping for cheap updates of info, mistakes, reuse, etc. The stickers also can become removable from magnet base (10) for reuse, recycle, etc. This headline (18) can also be translated into many languages.

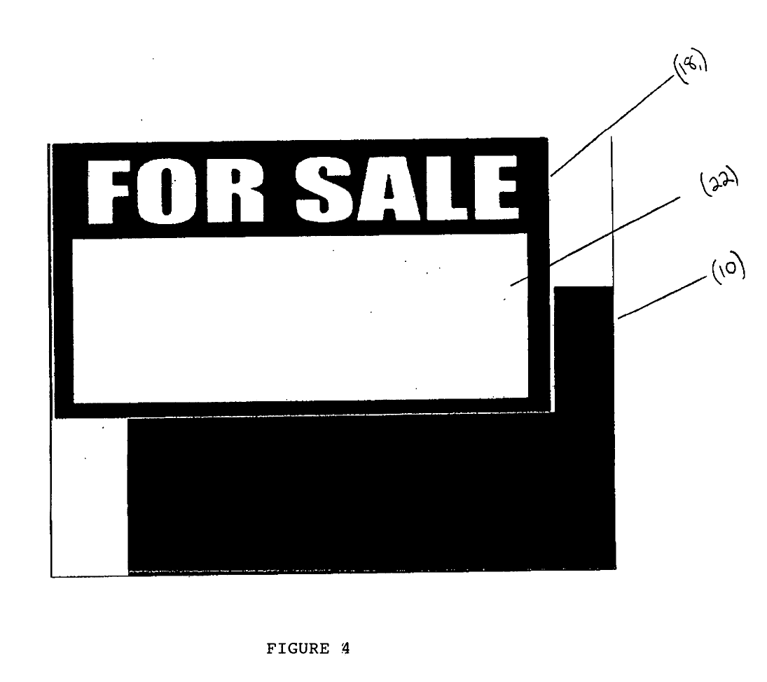

### FIG. 4 Alternative Embodiment

A large area (semi) permanent print out on ink absorbent vinyl (12,14,18,22) which adheres to a millimeter thick magnetic (10) sheet base. This enables permanent ink marker to be used as a basic form of adding personalized information or description (22). It also allows a professional printout of personal description to be printed directly into the open white space (22).

This headline (18) can also be translated into many languages.

### Advantages

From the description above, a number of advantages of my magnetic 4 SALE and FOR SALE signs become evident:

(a) a customizable platform for personal advertisement

(b) a reusable platform for personal advertisement

(c) a repositionable platform for personal advertisement

(d) a cheap and easy form of production

(e) does not obstruct a drivers view

(f) because of the ease of production many options become available, such as custom sizes, different languages, custom lettering, many color options become available, also glow in the dark off white backgrounds can be done as well.

(g) also with cheap replacement stickers an old sign or mistake can be updated and cheaply refurbished, easily with and with less shipping costs.

(h) the use of permanent ink absorbing material as a large area background makes the signs cheap and easy for anyone to use, update, or write on with any permanent ink marker.

(i) the product is relatively cheap to produce because of the large blank white area which is comprised of a base material which needs no embellishment.

(j) the product is flat and can be layered in numbers for easy shipment thru standard envelope, boxes, etc.

### Operation—FIGS. 1, 1B, 2, 3, 4

The manner of using the magnetic 4 SALE or FOR SALE sign as a personal advertiser or advertisement would be to write out a basic description of the vehicle or product that is for sale. First write a draft on a scrap piece of paper to figure what you want to write, don't forget to include a phone number or contact info. When you are ready to transfer the pre written description to the magnetic sign you may request a manufacturer to add it professionally or you may use a permanent ink marker to embellish your description and contact info on the blank white area of the face of the magnetic advertisement. It takes about sixty second for the marker ink to dry permanently into vinyl substrate so caution is advised not to touch or smear permanent marker ink for at least sixty seconds after permanent ink marker is applied. After this, if you have made a mistake you can cover up your mistake cheaply by applying a blank white replacement sticker sheet the existing surface, covering up any mistake below. A new headline sticker is also available to refurbish old and or faded signs. To apply, cut to approximate size of old platform, peel slightly and fold back one side of sticker sheet backing, place gently over area to be applied to while lining up corners, sides, etc. Gently stick exposed area to desired location, then with a ruler, gently slide across the face of the replacement sticker all the while peeling off the backing of the sticker.

After the description is presentable, the magnetic platform can be applied to most metallic objects such as automobiles, vehicles, refrigerators, etc. place magnet on most any surface. On vehicle side doors or trunk lid. While car is in motion, placement on roofs and hoods is recommended in parked none moving situations where forward visibility of advertisement is desired. The replacement headline stickers can also be placed on almost any other object.

### Conclusion, Ramifications, and Scope

Accordingly the reader will see that the 4 SALE and or the FOR SALE magnetic personal advertiser will provide broad coverage and many benefits, abilities, and options over the traditional form of personal advertisement signs, etc

This can be produced in many different ways and fashions

It provides can be produced in many languages

It allows product to be offered in many colors

It allows sign description to be personalized from the manufacturer

It provides shipped directly to customers

it allows a cheap to set up franchise business can also be licensed to others.

It provides a repositionable advertising platform

it allows an unobstructed view of a vehicle operator

Although the description above contains many specifics, they should not be construed as limiting the scope of the invention but as merely providing illustrations of some of the presently preferred embodiments of this invention.

I claim:

4. A removable advertisement signage, comprising:
a sheet having a sheet top surface and a sheet back surface having a layer of magnetic material with a predetermined amount of magnetic force;
a label with a label top surface and a label back surface having an adhesive adhering the label to the sheet top surface of the magnetic sheet;
wherein the sheet back surface of the sheet is removeably attached to a metallic substance by the predetermined amount of magnetic force of the magnetic material.

5. The removable advertisement signage of claim 4, wherein a message is printed on the label top surface in a reverse negative manner meaning that a pigment material applied to the label top surface becomes a background and areas of the label top surface free of the pigment material manifest the message.

6. The removable advertisement signage of claim 4, wherein one of a border and a frame appears on the label top surface.

7. The removable advertisement signage of claim 4, wherein the label only occupies a fraction of a total surface space of the sheet top surface.

8. The removeably advertisement signage of claim 4, wherein the label contains a written message.

9. The removable advertisement signage of claim 8, wherein the written message is written in one of an English language and a non-English language.

10. The removable advertisement signage of claim 9, wherein the written message is one of a “4 SALE”, a “4-SALE” and a “FOR SALE”.

11. The removable advertisement signage of claim 9, wherein the written message is one of a website address, a telephone number, a bar code and a sales price.

12. The removable advertisement signage of claim 10, wherein the label top surface has a color different from a color of the written message.

13. A method of making a removable advertisement signage, comprising a plurality of steps of:
a. selecting a sheet of base material having a sheet top surface and a sheet back surface having a layer of magnetic material with a predetermined amount of magnetic force;
b. adhering a label with an adhesive on a portion of the sheet top surface of the sheet of base material;
c. removeably attach the sheet back surface of the sheet to a metallic substance by the predetermined amount of magnetic force of the magnetic material.

14. The removable advertisement signage of claim 13, wherein a message is printed on the label top surface in a reverse negative manner meaning that a pigment material applied to the label becomes a background and areas of the label free of the pigment material manifest the message.

15. The removable advertisement signage of claim 13, wherein one of a border and a frame appears on the label.

16. The method of making a removable advertisement signage of claim 13, wherein the label only occupies a fraction of a total surface space of the sheet top surface.

17. The method of making a removable advertisement signage of claim 13, wherein the label contains a written message.

18. The method of making a removable advertisement signage of claim 17, wherein the written message is written in one of an English language and a non-English language.

19. The method of making a removable advertisement signage of claim 17, wherein the written message is one of a “4 SALE”, a “4-SALE” and a “FOR SALE”.

20. The method of making a removable advertisement signage of claim 18, wherein the written message is one of a website address, a telephone number, a bar code and a sales price.

21. The method of making a removable advertisement signage of claim 13, wherein the label has a color different from a color of the written message.

22. A method of making a removable advertisement sign, comprising a plurality of steps of:
a. selecting a sheet of base material having a sheet top surface and a sheet back surface having a layer of magnetic material with a predetermined amount of magnetic force;
b. printing a headline with permanent ink on a portion of the sheet top surface of the sheet of base material;
c. removably attach the sheet back surface of the sheet to a metallic substance by the predetermined amount of magnetic force of the magnetic material.

23. The removable advertisement signage of claim 22, wherein the headline is printed in a reverse negative manner meaning that a pigment material applied to the sheet top surface becomes a background of the headline and areas of the sheet top surface within a headline region free of the pigment material manifest the message.

24. The method of making a removable advertisement sign of claim 22, wherein the headline having one of a border and a frame.

25. The method of making a removable advertisement sign of claim 22, wherein the headline shows one of a “4 SALE”, a “4-SALE” and a “FOR SALE”.

26. The method of making a removable advertisement signage of claim 22, wherein the headline shows a written message.

27. The method of making a removable advertisement signage of claim 26, wherein the written message is in one of an English language and a non-English language.

28. The method of making a removable advertisement signage of claim 26, wherein the headline has a color different from a color of the written message.

29. The method of making a removable advertisement signage of claim 22, wherein the headline is one of a website address, a telephone number, a bar code and a sales price.
